(19) United States
(12) Patent Application Publication
(10) Pub. No.: US 2020/0050857 A1
(43) Pub. Date: Feb. 13, 2020

(54) METHODS AND SYSTEMS OF PROVIDING AUGMENTED REALITY

(71) Applicant: Verascan, Inc., Las Vegas, NV (US)

(72) Inventors: Fernando Giuseppe Anello, Las Vegas, NV (US); Cameron Robert Feather, Las Vegas, NV (US)

(73) Assignee: Verascan, Inc., Las Vegas, NV (US)

(21) Appl. No.: 16/535,076

(22) Filed: Aug. 8, 2019

Related U.S. Application Data
(60) Provisional application No. 62/716,306, filed on Aug. 8, 2018.

(51) Int. Cl. G06K 9/00; G06F 16/955; G06T 19/00; G06T 7/70

(52) U.S. Cl. CPC G06K 9/00671; G06F 16/9558; G06T 2207/30204; G06T 7/70; G06T 19/006

(57) ABSTRACT

A system, method, or web application for providing augmented reality. There is: imaging, using a user interface device operating a mobile web application, a plurality of frame-shaped augmented reality markers within a set of markers, each having an identifier that is unique within the set of markers, thereby generating set unique marker images; generating a plurality of marker templates with stored associated data; automatically identifying the specific frame-shaped augmented reality marker when imaged by its identifier via the mobile web application; automatically displaying data associated with the specific frame-shaped augmented reality marker on an augmented reality display wherein the data displayed is registered three-dimensionally with the specific frame-shaped augmented reality marker, wherein the frame-shaped augmented reality markers include machine-readable orientation information displayed thereon.

### CROSS-REFERENCE TO RELATED APPLICATIONS

This invention claims priority, under 35 U.S.C. § 120, to the U.S. Provisional Patent Application No. 62/716,306 by Fernando Giuseppe Anello et al., filed on Aug. 8, 2018, which is incorporated by reference herein in its entirety.

### BACKGROUND OF THE INVENTION

### Field of the Invention

The present invention relates to augmented reality, specifically to methods and systems of providing marker-based augmented reality through mobile user devices.

### Description of the Related Art

Augmented reality (AR) includes interactive user experiences of a real-world environment wherein object or locations within the real-world environment are associated with computer generated perceptions, generally through a visual interface such as a heads-up display or a mobile device. AR generally differs from virtual reality (VR), wherein the real-world experiences are substantially replaced in VR, while in AR, the experiences are blended together in some manner.

AR may be used in business, social, entertainment, educational, and other settings to provide users with enhanced information and/or perceptual experiences associated with real-world objects, events, and locations. Such may enhance the user experience and/or provide increases in efficacy, speed, quality, or other characteristics for work to be performed.

AR generally includes some sort of (generally, network enabled) user interface that is able to detect when/where/what is to be augmented and then, triggered thereby, produces the associated perceptual experience in association with the triggering event/object/location. Such perceptual experience may overlay over the event/object/location, may replace it entirely (in the experience of the user) or may be disposed “nearby” so as to add to the experience.

Such systems allow one to create virtual tours of locations, with enhanced embedded information. They may also be used in facilitating construction or other work efforts by placing critical information, plans, instructions, changes, etc. within the work environment or job site. They may be used in inventory management systems to provide enhanced instructions, guidance for restocking, and the like. They may be used in social settings to provide information about people, places, events. They may be used in plant/facility management/maintenance to provide real-time virtual information about systems and processes associated therewith at locations within a facility wherein actions may be taken based on that information. They may be used in entertainment events to provide a more interactive, informative, and intense experience for an audience, as well as providing for location-based experiences not otherwise possible or economically feasible. Non-limiting examples of such entertainment experiences include those provided under the names: Pokemon Go; Ingress; Zombies, Run!; Invizimals; Kazooloo; Harry Potter: Wizards Unite, and the like.

Some improvements have been made in the field. Examples of references related to the present invention are described below in their own words, and the supporting teachings of each reference are incorporated by reference herein:

U.S. Pat. No. 9,607,437 to Reisner-Kollmann et al. teaches a method for defining virtual content for real objects that are unknown or unidentified at the time of the development of the application for an augmented reality (AR) environment. For example, at the time of development of an AR application, the application developer may not know the context that the mobile device may operate in and consequently the types or classes of real object and the number of real objects that the AR application may encounter. In one embodiment, the mobile device may detect unknown objects from a physical scene. The mobile device may then associate an object template with the unknown object based on the physical attributes, such as height, shape, size, etc., associated with the unknown object. The mobile device may render a display object at the pose of the unknown object using at least one display property of the object template.

US Patent Application Ser. No. 2011/0,310,227 by Konertz et al. teaches methods, apparatuses, and systems are provided to facilitate the deployment of media content within an augmented reality environment. In at least one implementation, a method is provided that includes extracting a three-dimensional feature of a real-world object captured in a camera view of a mobile device, and attaching a presentation region for a media content item to at least a portion of the three-dimensional feature responsive to a user input received at the mobile device.

US Patent Application Ser. No. 2015/0,185,825 by Mullins teaches a system and method for assigning a virtual user interface to a physical object is described. A virtual user interface for a physical object is created at a machine. The machine is trained to associate the virtual user interface with identifiers of the physical object and tracking data related to the physical object. The virtual user interface is displayed in relation to the image of the physical object.

US Patent Application Ser. No. 2015/0,040,074 by Hoffman teaches methods and systems for enabling creation of augmented reality content on a user device including a digital imaging part, a display, a user input part and an augmented reality client, wherein said augmented reality client is configured to provide an augmented reality view on the display of the user device using an live image data stream from the digital imaging part are disclosed. User input is received from the user input part to augment a target object that is at least partially seen on the display while in the augmented reality view. A graphical user interface is rendered to the display part of the user device, said graphical user interface enabling a user to author augmented reality content for the two-dimensional image.

The inventions heretofore known suffer from a number of disadvantages, including but not limited to one or more of: being difficult to use, not operating/updating in real-time, failing to allow implementation of actional information, not being dynamically updatable, failing to improve team collaboration, not improving task management, being difficult to set up, not having durable markers, having a complicated interface, not being mobile friendly, not being platform agnostic, requiring intensive processor function, using too much data, not being adaptable for teams, not being instantly shareable, not able to be updated by team members, failing to provide for cross-browser or cross-device compatibility, requiring high power consumption from mobile devices, failing to help maintain situational awareness, requiring substantial screen time, and/or failing to provide for rapid marker identification.

What is needed is a system and/or method that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available systems, applications, and methods. Accordingly, the present invention has been developed to provide a method, system, and application for providing augmented reality.

According to one embodiment of the invention, there is a method of providing an augmented reality service over a computerized network utilizing a mobile web application. The method may include one or more of the steps of: imaging, using a user interface device operating a mobile web application, a plurality of frame-shaped augmented reality markers within a set of markers, each having an identifier that is unique within the set of markers, thereby generating set unique marker images; automatically storing data in association with each of the plurality of set unique marker images, thereby generating a plurality of marker templates; automatically storing the plurality of marker templates in association with each other, imaging, using a user interface device operating the mobile web application, a specific frame-shaped augmented reality marker which is one of the plurality of frame-shaped augmented reality markers; automatically identifying the specific frame-shaped augmented reality marker by its identifier via the mobile web application; automatically displaying data associated with the specific frame-shaped augmented reality marker on an augmented reality display wherein the data displayed is registered three-dimensionally with the specific frame-shaped augmented reality marker, wherein the frame-shaped augmented reality markers include machine-readable orientation information displayed thereon.

It may be that the identifiers are not globally unique within the system. It may be that the displayed data includes a hyperlink that links to additional data. It may be that the machine-readable orientation information includes an asymmetric bi-color frame coloring schema. It may be that the frame-shaped augmented reality markers include one or more access codes disposed thereon and wherein the step of automatically storing data requires an access code from at least one of the frame-shaped augmented reality markers.

In another non-limiting embodiment of the invention, there may be a mobile web application operating on a mobile computing device for providing marker-based augmented reality, that may include one or more of: a file input submission form that automatically uploads files into a database in associated with frame-shaped markers having machine-readable orientation information disposed thereon and frame identifiers that are unique within a set of frames but not globally unique that are scanned via a video input device; and/or a graphical user interface that displays uploaded files in marker-based augmented reality in three dimensionally registered associated with frame-shaped markers.

It may be that the displayed data includes a hyperlink that links to additional data. It may be that the machine-readable orientation information includes an asymmetric bi-color frame coloring schema. It may be that the frame-shaped augmented reality markers include one or more access codes disposed thereon and wherein the step of automatically storing data requires an access code from at least one of the frame-shaped augmented reality markers.

In still another non-limiting embodiment of the invention, there may be a system for providing augmented reality over a computerized network, that may include one or more of: a plurality of distributed markers with machine-readable orientation information disposed thereon and having machine-readable identifiers disposed thereon; a user interface device operating a web application having: a video scanner capable of capturing video information and reading the orientation information and the identifiers of the distributed markers; a file input submission form that associates data with scanned markers thereby forming associated data and submits the associated data; and/or an augmented reality display that displays associated data in three-dimensional registration with captured video data and visible distributed markers: and/or a backend system that stores associated data and provides associated data over a network to the web application when queried for the associated data by the identifier included within the associated data.

It may be that the distributed markers are frame-shaped. It may be that the machine-readable identifiers are unique within a set of distributed markers but are not unique within the system. It may be that the machine-readable orientation information consists of asymmetric marker coloration. It may be that the data includers data selected from the group of data consisting of: image files, spreadsheets, and hyperlinks. It may be that the distributed markers include one or more access codes disposed thereon and wherein the step of automatically storing data requires an access code from at least one of the markers.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a network diagram of a system of providing AR, according to one embodiment of the invention;

FIG. 2 is a module diagram showing a user interface device, according to one embodiment of the invention;

FIG. 3 is a module diagram showing a backend system, according to one embodiment of the invention;

FIG. 4 is a front view of a marker according to one embodiment of the invention;

FIG. 5 is a front perspective view of a marker according to one embodiment of the invention;

FIG. 6 is a side view of a marker according to one embodiment of the invention; and

FIG. 7 is a sequence diagram showing a method of providing AR, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

Many of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of processors. An identified module of programmable or executable code may, for instance, comprise one or more physical or logical blocks of computer instructions which may, for instance, be organized as an object, procedure, or function.

Nevertheless, the executables of an identified module need not be physically located together, but may comprise disparate instructions stored in different locations which, when joined logically together, comprise the module and achieve the stated purpose for the module. Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server, motherboard, network, chipset or other computing system including a processor for processing digital data; a memory device coupled to a processor for storing digital data; an input digitizer coupled to a processor for inputting digital data; an application program stored in a memory device and accessible by a processor for directing processing of digital data by the processor; a display device coupled to a processor and/or a memory device for displaying information derived from digital data processed by the processor; and a plurality of databases including memory device(s) and/or hardware/software driven logical data storage structure(s).

Various databases/memory devices described herein may include records associated with one or more functions, purposes, intended beneficiaries, benefits and the like of one or more modules as described herein or as one of ordinary skill in the art would recognize as appropriate and/or like data useful in the operation of the present invention.

As those skilled in the art will appreciate, any computers discussed herein may include an operating system, such as but not limited to: Android, iOS, BSD, IBM z/OS, Windows Phone, Windows CE, Palm OS, Windows Vista, NT, 95/98/2000, OS X, OS2; QNX, UNIX; GNU/Linux: Solaris; MacOS: and etc., as well as various conventional support software and drivers typically associated with computers. The computers may be in a home, industrial or business environment with access to a network. In an exemplary embodiment, access is through the Internet through a commercially-available web-browser software package, including but not limited to Internet Explorer, Google Chrome, Firefox, Opera, and Safari.

The present invention may be described herein in terms of functional block components, functions, options, screen shots, user interactions, optional selections, various processing steps, features, user interfaces, and the like. Each of such described herein may be one or more modules in exemplary embodiments of the invention even if not expressly named herein as being a module. It should be appreciated that such functional blocks and etc. may be realized by any number of hardware and/or software components configured to perform the specified functions. For example, the present invention may employ various integrated circuit components, e.g., memory elements, processing elements, logic elements, scripts, look-up tables, and the like, which may carry out a variety of functions under the control of one or more microprocessors or other control devices. Similarly, the software elements of the present invention may be implemented with any programming or scripting language such as but not limited to Eiffel, Haskell, C, C++, Java, Python, COBOL, Ruby, assembler, Groovy, PERL, Ada, Visual Basic, SQL Stored Procedures, AJAX, Bean Shell, and extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units, third party devices/systems and/or modules. Being “in communication” refers to any manner and/or way in which functional units and/or modules, such as, but not limited to, computers, networks, mobile devices, program blocks, chips, scripts, drivers, instruction sets, databases and other types of hardware and/or software, may be in communication with each other. Some non-limiting examples include communicating, sending, and/or receiving data and metadata via: a wired network, a wireless network, shared access databases, circuitry, phone lines, internet backbones, transponders, network cards, busses, satellite signals, electric signals, electrical and magnetic fields and/or pulses, and/or so forth.

As used herein, the term “network” includes any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using other protocols, including but not limited to IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

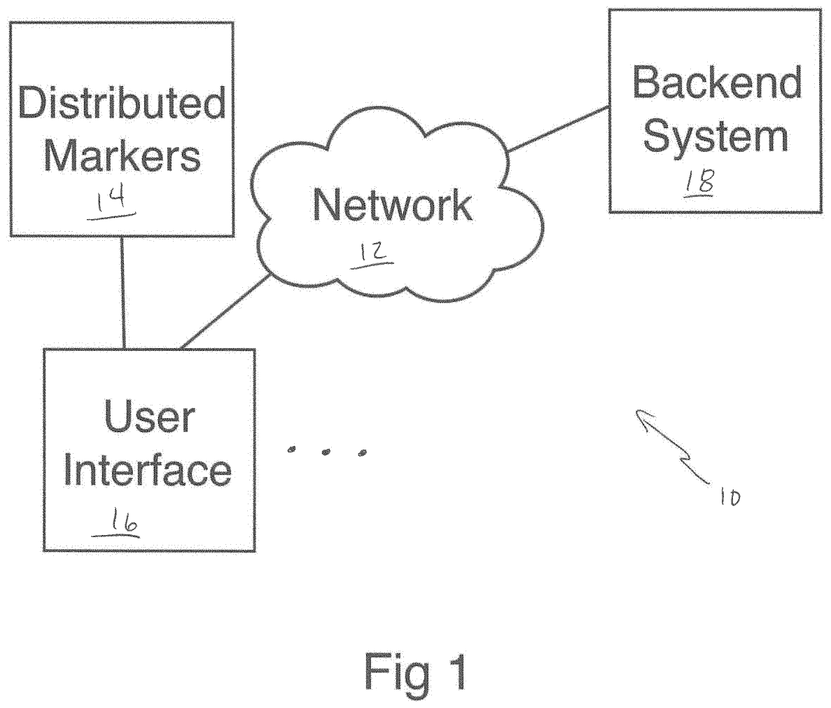

FIG. 1 is a network diagram of a system 10 of providing AR, according to one embodiment of the invention. There is shown a backend system 18 coupled to a plurality of user interface devices 16 over a network 12, with the user interface devices 16 in functional communication with distributed markers 14. The illustrated system allows for users to distribute markers within a real-world environment, upload content through their user interface devices to be automatically associated therewith to the backend system, and to then experience AR generated by the automatic association of the content with the distributed markers. Such a system may be easily and quickly implemented by a plurality of users and may be updated/adapted over time in real-time and without requiring that the users learn programming languages.

The illustrated distributed markers provide for visual indicators that may be coupled to real-world locations/objects and/or otherwise associated with real-world events (e.g. attached to an object, but hidden until a particular moment in time) such that the system may recognize and identify the markers, thereby triggering the associated AR operations (e.g. displaying content through a display device, playing audio, releasing scent). The distributed markers may include an attachment device, such as but not limited to screws, clips, adhesives, tacks, pins, zippers, and the like and combinations thereof to allow them to be coupled to real-world objects. The distributed markers may include visual, or otherwise detectable components, that allow for them to be identified in relation to their backgrounds by user interface devices described herein. As a non-limiting example, a marker may include shapes, colors, lighting, and the like and combinations thereof that allow an image recognition system (e.g. of a smartphone) to recognize that it has a marker in its view. Such may include further details that allow the marker to be uniquely identified, at least within an account, such that the user interface device may be able to recognize which marker it is. A distributed marker is a marker that is placed within the real-world.

The illustrated user interface devices are in communication with the backend system over a computerized network. The user interface devices may include a graphical user interface module and may include devices and programming sufficient to communicate with a network and the backend system, to display AR content in association with real-world content, and the like. Generally, such may be in the form of a smartphone, personal computer, AR glasses, dumb-terminal, tablet, or the like, but other embodiments are contemplated. Such will generally include a processor, a display device (e.g. monitor, tv, touchscreen), an audio device (e.g. speaker, microphone), memory, a bus, a user input device (e.g. controller, keyboard, mouse, touchscreen), and a communication device (e.g. a network card, wireless transponder), each in communication with one or more of the others as appropriate for the function thereof, generally over the bus. There may be a plurality and a variety of such graphical user interface modules in communication with the system over the network, with some being for users, merchants, other consumers, marketers, etc. and combinations thereof.

The illustrated backend system allows for centralized (or distributed, if it is implemented in a distributed manner) management, storage, control, and etc. of functions of the AR system. The backend system reduces the processing and storage requirements of the user interface devices and allows them to share, in real-time, information, updates, and the like across the system.

The illustrated network provides communication between the various devices, modules and systems. The network may be a public network, such as but not limited to the world-wide-web, or a private network, such as a corporate intranet. It may be provided through a multiplicity of devices and protocols and may include cellular phone networks and the like and combinations thereof.

In one non-limiting embodiment, there is a web-based productivity and risk management tool that allows the user to create their own AR layer for team collaboration that is shareable and updatable. The same tool can be used for trend analysis to reduce errors and redundancies in any process, especially the construction and industrial processes.

In one non-limiting embodiment, there are automated processes for rending a display object that is textured with user input at the 3D pose of its corresponding fiducial marker. In such, user input is prepared to texture the 3D object template. Each set of inputs is associated with a unique identifier, that is unique within its own set.

In one non-limiting embodiment, there is a web-based AR editor and display with physical markers that are unique within the set having simple marker codes.

In one non-limiting embodiment, when a user submits or updates the editor after filing in the submission form, the system styles the input and associates it with a particular marker and updates the database so that the AR architecture can be updated in real-time.

In one non-limiting embodiment, there is a plurality of packets of adhesive AR markers, wherein each marker within a packet is unique within the packet and the packets are unique to each other, via an indicator (e.g. initialization number).

In one non-limiting embodiment, there is a user interface provided by an AR system that handles file input submissions and automatically displays such files in AR.

According to one embodiment of the invention, there is a method of providing an augmented reality service over a computerized network utilizing a mobile web application. The method may include one or more of the steps of: imaging, using a user interface device operating a mobile web application, a plurality of frame-shaped augmented reality markers within a set of markers, each having an identifier that is unique within the set of markers, thereby generating set unique marker images; automatically storing data in association with each of the plurality of set unique marker images, thereby generating a plurality of marker templates; automatically storing the plurality of marker templates in association with each other, imaging, using a user interface device operating the mobile web application, a specific frame-shaped augmented reality marker which is one of the plurality of frame-shaped augmented reality markers; automatically identifying the specific frame-shaped augmented reality marker by its identifier via the mobile web application; automatically displaying data associated with the specific frame-shaped augmented reality marker on an augmented reality display wherein the data displayed is registered three-dimensionally with the specific frame-shaped augmented reality marker, wherein the frame-shaped augmented reality markers include machine-readable orientation information displayed thereon.

It may be that the identifiers are not globally unique within the system. It may be that the displayed data includes a hyperlink that links to additional data. It may be that the machine-readable orientation information includes an asymmetric bi-color frame coloring schema. It may be that the frame-shaped augmented reality markers include one or more access codes disposed thereon and wherein the step of automatically storing data requires an access code from at least one of the frame-shaped augmented reality markers.

In another non-limiting embodiment of the invention, there may be a mobile web application operating on a mobile computing device for providing marker-based augmented reality, that may include one or more of: a file input submission form that automatically uploads files into a database in associated with frame-shaped markers having machine-readable orientation information disposed thereon and frame identifiers that are unique within a set of frames but not globally unique that are scanned via a video input device; and/or a graphical user interface that displays uploaded files in marker-based augmented reality in three dimensionally registered associated with frame-shaped markers.

It may be that the displayed data includes a hyperlink that links to additional data. It may be that the machine-readable orientation information includes an asymmetric bi-color frame coloring schema. It may be that the frame-shaped augmented reality markers include one or more access codes disposed thereon and wherein the step of automatically storing data requires an access code from at least one of the frame-shaped augmented reality markers.

In still another non-limiting embodiment of the invention, there may be a system for providing augmented reality over a computerized network, that may include one or more of: a plurality of distributed markers with machine-readable orientation information disposed thereon and having machine-readable identifiers disposed thereon; a user interface device operating a web application having: a video scanner capable of capturing video information and reading the orientation information and the identifiers of the distributed markers; a file input submission form that associates data with scanned markers thereby forming associated data and submits the associated data; and/or an augmented reality display that displays associated data in three-dimensional registration with captured video data and visible distributed markers; and/or a backend system that stores associated data and provides associated data over a network to the web application when queried for the associated data by the identifier included within the associated data.

It may be that the distributed markers are frame-shaped. It may be that the machine-readable identifiers are unique within a set of distributed markers but are not unique within the system. It may be that the machine-readable orientation information consists of asymmetric marker coloration. It may be that the data includers data selected from the group of data consisting of: image files, spreadsheets, and hyperlinks. It may be that the distributed markers include one or more access codes disposed thereon and wherein the step of automatically storing data requires an access code from at least one of the markers.

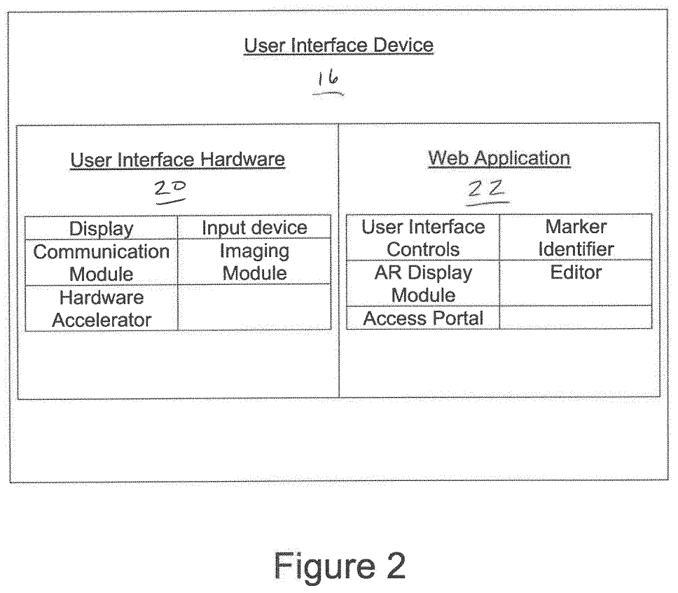

FIG. 2 is a module diagram showing a user interface device 16, according to one embodiment of the invention. There is shown user interface hardware 20 in functional communication with a web application 22, such that the web application 22 may operate on the hardware 20.

The illustrated user interface hardware includes a display, an input device, a communication module, an imaging module, and a hardware accelerator. Thereby, the user interface device may display 3D objects on the display, may receive and analyze visual input data (e.g. real-time images or videos of the real-world), and may upload data to the backend system. The web application includes user interface controls, a marker identifier, an AR display module, an editor, and an access portal. Thereby the web application may facilitate the AR experience of the user and enable the same to edit/update the same.

The illustrated display may include one or more hardware/software display components, such as but not limited to LED displays, CRT displays, projected displays, display drivers, and the like and combinations thereof. Such displays may also include user interface inputs, such as but not limited to touch-screens and the like.

The illustrated input device may include one or more keyboards, touch-screens, mouse devices, rollerballs, light pens and the like and combinations thereof.

The illustrated communication module, such as but not limited to a network card, system bus, or wireless communication module, communicates with a computerized network. The communication module provides communication capabilities, such as wireless communication, to the modules and components of the system and the components and other modules described herein. The communication module provides communication between a wireless device, such as a mobile phone, and a computerized network and/or to facilitate communication between a mobile device and other modules described herein. The communication module may have a component thereof that is resident on a user's mobile device or on a user's desktop computer. Non-limiting examples of a wireless communication module may be but not limited to: a communication module described in U.S. Pat. No. 5,307,463, issued to Hyatt et al.; or a communication module described in U.S. Pat. No. 6,133,886, issued to Fariello et al., which are incorporated for their supported herein.

The illustrated hardware accelerator (or GPU) facilitates the display of 3D graphics on the user interface device. Hardware accelerators using a customized hardware logic device or a co-processor can improve the performance of a graphics system by implementing graphics operations within the device or co-processor. The hardware accelerator usually is controlled by the host operating system program through a driver program. Host operating systems typically initialize by performing a survey of the hardware that is attached to the system when the system is powered on. A hardware driver table is compiled in the system memory identifying the attached hardware and the associated driver programs. Some operating systems will expand the characterization of hardware graphic accelerators by entering performance characterizations of the attached hardware. Speed and accuracy characterizations can be stored for the various graphic rendering operations available from a particular hardware accelerator. The host operating system will compare the speed and accuracy of the attached hardware accelerator with that of the host rendering programs that are included with the host operating system. This is done for each graphic primitive available in the hardware. The host operating system then decides which graphics primitives should be rendered by the host graphics rendering programs and which by the attached hardware accelerator. Then, when applications call for the drawing of a particular graphic primitive, it is the host operating system that controls whether the hardware accelerator is selected or whether the host rendering program is selected to render it in the video memory.

There are a large number of hardware accelerators currently available. These accelerators speed the rendering of graphics operations by using dedicated hardware logic or co-processors, with little host processor interaction. Hardware accelerators can be simple accelerators or complex co-processors. Simple accelerators typically accelerate rendering operations such as line drawing, filling, bit block transfers, cursors, 3D polygons, etc. Co-processors in addition to rendering accelerations, enable multiprocessing, allowing the co-processor to handle some time consuming operations.

The illustrated communication module, such as but not limited to a network card, system bus, or wireless communication module, communicates with a computerized network. The communication module provides communication capabilities, such as wireless communication, to the modules and components of the system and the components and other modules described herein. The communication module provides communication between a wireless device, such as a mobile phone, and a computerized network and/or to facilitate communication between a mobile device and other modules described herein. The communication module may have a component thereof that is resident on a user's mobile device or on a user's desktop computer. Non-limiting examples of a wireless communication module may be but not limited to: a communication module described in U.S. Pat. No. 5,307,463, issued to Hyatt et al.; or a communication module described in U.S. Pat. No. 6,133,886, issued to Fariello et al., which are incorporated for their supported herein.

The illustrated user interface controls allow for the user to selectably provide input into the web application and may include instructions for operation of one or more user input devices, as described herein.

The illustrated marker identifier includes instructions for recognizing and identifying markers from video/image data captured by the user interface device (e.g. by the camera of the device). The marker identifier may include one or more image recognition tools and one or more image templates for comparing received image data to recognize and identify markers as they are “seen” by the device. Such may include image processing tools, such as but not limited to color filters, image transform tools (e.g. various Fourier transforms), pattern recognizers, OCR tools, shape recognition tools, and the like. Such may also include image libraries and the like, to which recognized images may be compared and scored.

The illustrated AR display module displays AR data in association with real-world data. Generally, this takes the form of overlaying 3D graphic objects onto a real-time video feed of captured image data from the real world. In the context of a smartphone, it may take the form of placing a 3D object over the top of a portion of a video feed from the camera of the smartphone that is displayed on the display of the smartphone and moving and reorienting that 3D object as the smartphone changes in location and orientation, with the 3D object “pinned” to a marker that is visible by the camera of the phone.

The illustrated editor includes an upload tool and one or more input submission forms. The upload tool includes software that communicates via the communication module with the backend system to allow for data (e.g. 2D/3D image/video files, text/numerical information), to be transmitted from the user interface device to the backend system for manipulation and storage thereby. The input submission forms include user input locations/windows that may be labeled to identify which kind of input is expected (e.g. image title, description, special instructions, links to additional information, marker id, project id). The input submission forms are generated in cooperation with the data translation of the backend system, such that the data received by the input submission form will be of a sort and format that is usable by the system and able to be translated to the AR database format. The submission forms may also include other data that is not specifically input by the user, but may be obtained elsewhere (e.g. the form may arise on imaging a new distributed marker and that marker id may be automatically included with the form).

The illustrated access portal provides access to the backend system through the network. Such may include login tools and security protocols necessary to access and connect with the backend system over a particular protocol.

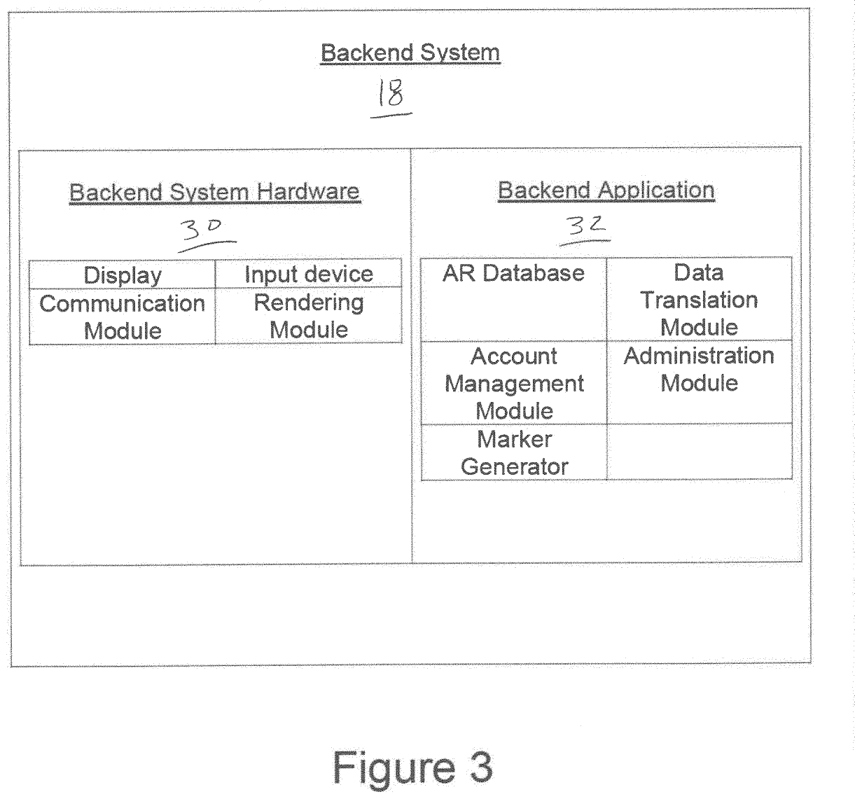

FIG. 3 is a module diagram showing a backend system 18, according to one embodiment of the invention. There is shown a backend system 18 having backend system hardware 30 and a backend application 32 in operational communication therewith.

The illustrated hardware includes a display, an input device, a communications module, and a rendering module (includes a CPU, bus, etc.). Thereby the illustrated backend system may be managed by a user (e.g. administrator), may communicate over the network, and may provide processing intensive rendering services to connected devices (e.g. user interface devices). The backend application, which runs on the hardware includes an AR database, a data translation module, an account management module, an administration module, and a marker generator. Accordingly, the backend system may store and access AR data in a format that allows it to serve the same to connected user interface devices in a manner that provides a desired AR experience and also allows those users to update, change, or create such experiences without having to program the same or interact directly with the database.

The illustrated display may include one or more hardware/software display components, such as but not limited to LED displays, CRT displays, projected displays, display drivers, and the like and combinations thereof. Such displays may also include user interface inputs, such as but not limited to touch-screens and the like.

The illustrated input device may include one or more keyboards, touch-screens, mouse devices, rollerballs, light pens and the like and combinations thereof.

The illustrated communication module, such as but not limited to a network card, system bus, or wireless communication module, communicates with a computerized network. The communication module provides communication capabilities, such as wireless communication, to the modules and components of the system and the components and other modules described herein. The communication module provides communication between a wireless device, such as a mobile phone, and a computerized network and/or to facilitate communication between a mobile device and other modules described herein. The communication module may have a component thereof that is resident on a user's mobile device or on a user's desktop computer. Non-limiting examples of a wireless communication module may be but not limited to: a communication module described in U.S. Pat. No. 5,307,463, issued to Hyatt et al.; or a communication module described in U.S. Pat. No. 6,133,886, issued to Fariello et al., which are incorporated for their supported herein.

The illustrated data translation module converts and/or conditions data entered by users through their user interface devices into data suitable for associating uploaded user input into AR database formatting. As non-limiting examples, such may include scripts for styling user input for AR, attaching metadata to uploaded content, and the like and combinations thereof. Such may include automatically formatting uploaded user information according to a script based on where in the user interface template the information is provided and/or may include automatically including default information according to a default format where information is not provided. Such may include automatically formatting text input as being numerical input or otherwise changing one or more aspects of the input to match with how data is stored within the AR database, such that it may be automatically updated with the uploaded/changed user input so that the AR experience of the users associated therewith may be changed in real-time without requiring that the users be able to program.

As a non-limiting example, a user may upload, using an upload template provided through the web interface, a 2D image and link, using a drop-down list provided through the user interface, that 2D image to a particular distributed marker. The user may then upload the 2D image with a text title associated therewith. The data translation module, on receipt of the same, may automatically convert the 2D image to a 3D image and store the same within the AR database and may, append a metatag to the 3D image file, the metatag appended may include the default orientation for the 3D image to be displayed in association with the particular linked distributed marker. Thus, when the same or another user queries the AR database using the identifier for that particular distributed marker, their user interface will be fed the converted 3D image in association with the marker in a position and orientation that matches the default orientation associated with the related account. All this is accomplished without the user having to know anything about database programming.

The illustrated marker generator generates visual codes for the markers and/or the account numbers and associates them together in an account. This operation will generally be done at the manufacturing stage of packets of markers. The visual codes may then be printed on blank marker templates for later use and distribution. The marker generator may also automatically generate the associated accounts, or those may be later generated when users first attempt to use the markers in the produced packet(s).

The illustrated administration module is configured to provide administrative controls to an administrator of the system. The administration module is configured to set and edit various parameters and settings (e.g. access/authorization settings) for the various modules, users, account, and/or components of the system. The administration module is configured to generate and regulate the use of each author or user profile or account over a computerized network. Non-limiting examples of an administration module may be an administration module as described in U.S. Patent Publication No.: 2011/0125900, by Janssen et al.; or an administration module as described in U.S. Patent Publication No.: 2008/0091790, by Beck, which are incorporated for their supporting teachings herein.

The illustrated rendering module prepares 3D object templates, e.g. dimensions and orientations and manages the display location and orientation of uploaded content that is associated with particular markers displayed in the real-world environment. Such may include a control module that provides operational instructions and commands to the modules and components of the display of the user interface device. There may be a rendering engine that generates 3D images/video based on one or more scripts (e.g. projecting a 2D image onto a first surface of a thin 3D plane). The rendering module may automatically generate 3D image metadata for generated 3D objects and store them in association with such 3D objects. The rendering module may also provide display information to user interface devices on how to transform the display of the 3D objects to match up with a perceived orientation of a distributed marker. Such may be accomplished via known image vectoring display techniques used in displaying 3D objects on 2D displays and may provide instructions for one or more hardware accelerators, such that those present on user interface devices.

The illustrated AR database may include a data storage module in communication with the modules and components of the system. The data storage module stores data one or more other the modules of the system 10. The data storage module is in communication with the various modules and components of the system and stores data transferred there through. The data storage module stores data transferred through the various other modules of the system, thereby updating the system with up to date data and real-time data. The data storage module securely stores user data and product data along with data transferred through the system. Data storage modules may be parts of databases and/or data files and include memory storage device(s) which may be, but are not limited to, hard drives, flash memory, optical discs, RAM, ROM, and/or tapes. A non-limiting example of a data base is Filemaker Pro 11, manufactured by Filemaker Inc., 5261 Patrick Henry Dr., Santa Clara, Calif., 95054. Non-limiting examples of a data storage module may include: a HP Storage Works P2000 G3 Modular Smart Array System, manufactured by Hewlett-Packard Company, 3000 Hanover Street, Palo Alto, Calif., 94304, USA; or a Sony Pocket Bit USB Flash Drive, manufactured by Sony Corporation of America, 550 Madison Avenue, New York, N.Y., 10022.

The account management module manages various accounts and is configured to manage and store personal user information, group account information, uploaded content, settings, preferences, and parameters for use with the AR experience and system. The account management module is configured to store user metadata and content, based upon user input. Non-limiting examples of a account management modules may be a user account including demographic information about a user as well as preference information about a user that is associated therewith. Such information may include preferred user interface display parameters, marker labeling scripts, orientation and/or setoff defaults for uploaded content and the like and combinations thereof. Such may be embodied in a database or other data structure/hierarchy such that the data associated with each user may be used by one or more modules described herein and/or may be altered and/or added to by one or more modules described herein. Non-limiting examples of a account management module may be an account management module as described in U.S. Patent Publication No.: 2003/0014509; or a management module as described in U.S. Pat. No. 8,265,650, which are incorporated for their supporting teachings herein.

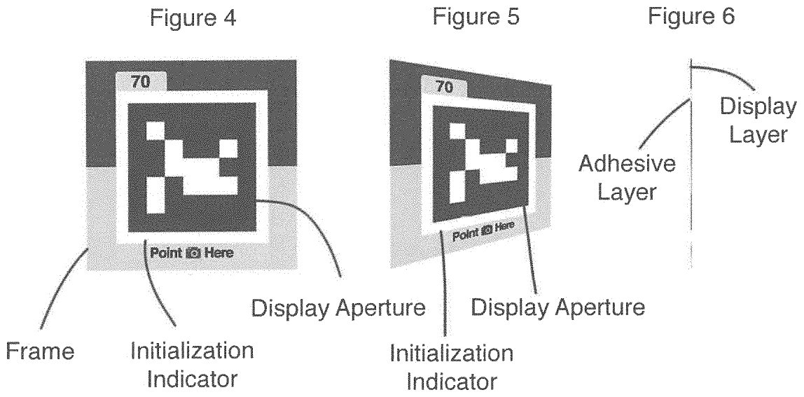

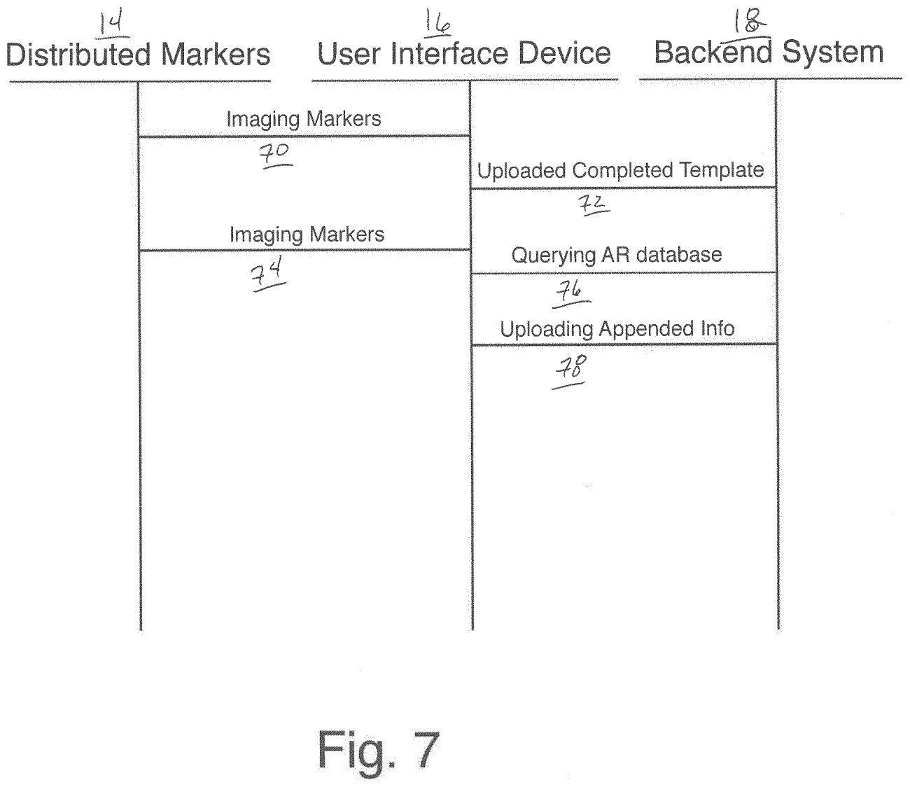

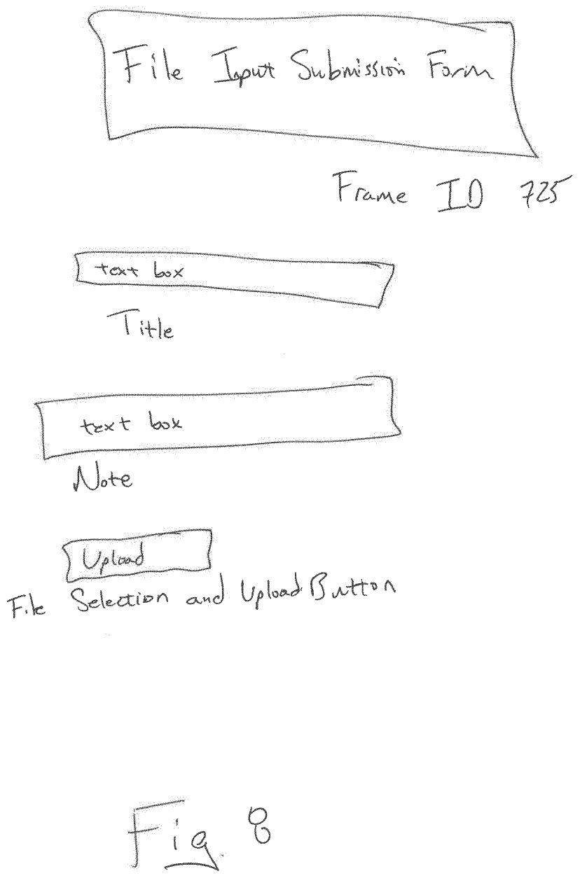

FIGS. 4-6 illustrate various views of a marker according to one embodiment of the invention. There is shown a square-shaped marker with a display aperture therethrough. The marker includes markings that are asymmetric and may thus be utilized by the system to uniquely identify the position and orientation of the marker with respect to its surroundings in the real-world. The illustrated marker also includes an initialization indicator that helps users know how to operate with the marker, especially when they are initializing an AR setup. The illustrated marker includes a layer of adhesive on the back so that it may be coupled to various surfaces. The illustrated marker includes left-right symmetrical (but top-bottom asymmetrical) bi-color coloring that provides machine-readable orientation information which allows the system to determine the position and orientation of the frame within the field of view of the video input device of the user interface device. This allows the system to then generate a three-dimensional position and orientation of the frame with in the video data and thereby display registered associated data (e.g. pdf files, image files, spreadsheet data, hyperlinks) on the display of the user interface while the user interface is receiving video input that includes the frame within the field of view.

In operation, there may be a packet of markers that may be each associated with a particular account. The markers may include specific asymmetric indicators of orientation that are unique between the various markers of the set or may otherwise include markings that make them unique within the set. It may be that they are not unique as compared to other sets. Thereby, a set of markers may be sold to a particular user group, who may use markers that appear identical to those of another user group, but operate differently, based on which account the markers are associated with. Thus the variation and complexity of marker identification may be drastically reduced and also the processing requirements of the associated image identification.

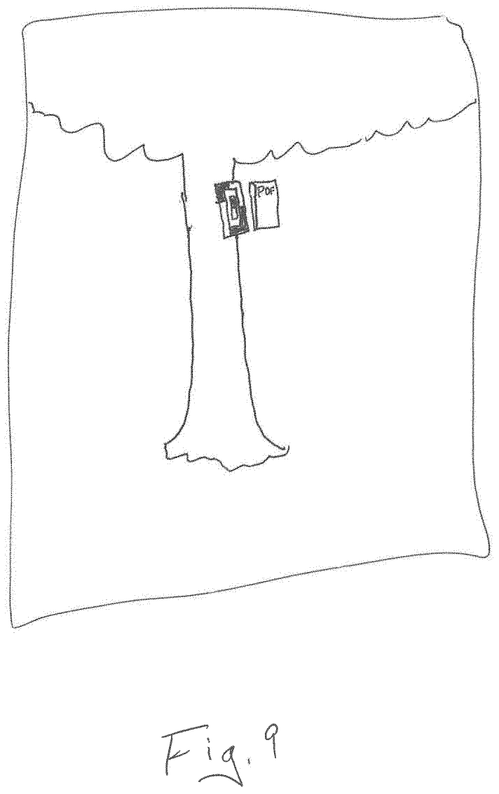

FIG. 7 is a sequence diagram showing a method of providing AR, according to one embodiment of the invention. There is shown a set of distributed markers 14, a user interface device(s) 16, and a backend system 18, in functional communication with each other. The user interface device 16 is able to image the distributed markers 14 and is able to communicate over a network with the backend system 18.

In the illustrated sequence, the user interface device images 70 the distributed marker(s) and, after filling out the upload template with associated information, uploads 72 the same to the backend system. The backend system translates the upload information to a form usable by the AR database and thereby populates the same, in association with the imaged distributed markers. The user interface may then later image 74 the same markers and be provided with the desired AR experience after querying 76 the AR database of the backend system. The user interface device may later upload 78 amended/appended information to the backend system, which may then be converted/translated to a firm usable by the AR database and then update the same for future AR experiences. This may all be done in real-time without requiring computer programmers to generate the datasets necessary.

FIG. 8 shows a prophetic view of a file input submission user interface of a mobile web application, according to one embodiment of the invention. There is shown a Frame ID 725 which references a frame identifier that is unique within a set of 1,000 frames (e.g. Frames 000-999), but not unique to a system including only three digit identifiers but more than 1,000 frames. There is shown a text box labeled “Title” wherein a user may enter a title to be associated with Frame 725. There is shown a text box labeled “Note” wherein a user may enter a note to be associated with Frame 725. There is shown an upload button wherein a user may search their device for a file to associate with Frame 725 and then upload to a backend system connected thereto, such that when Frame 725 is later viewed through a web-based mobile application and the backend system is queried, the file may be displayed in associated therewith.

FIG. 9 shows a prophetic screenshot of an augmented reality display showing a tree having a distributed frame-shaped marker coupled thereto at an angle away from a straight-on view thereof by the user interface device and displaying, in three-dimensional registration therewith on the same display a 3D icon of a PDF file disposed a short distance out in front of the marker and at approximately the same angle off of a straight-on view as the frame.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

As non-limiting examples, while the system is described herein as:
being web-based, i.e. a smartphone application with web-access capability, such may instead or also be a native application, a local network application, and/or a peer-to-peer distributed system (e.g. cryptocurrency system);
having physical markers of a particular shape and configuration, it is understood that the shapes and configurations of the same are plethoric and may include different shapes, configurations and relative sizes than those displayed, may include a variety of colors, and may even include marker pens with instructions on how to make the markers, include adhesive note paper with shaded in boxes in a grid, or even may be placed by spray-painting marker templates;
data translation may skip data styling that may be good database management but is not necessary to make it work

Further, the illustrated system may be implemented in a great variety of settings, including but not limited to in construction, security systems to secure access to facilities, medical triage situations (e.g. in an emergency room), first responder site setup, arborist in a garden or orchard, assembly line, manufacturing plant, site tour, shipping facility, utility marking, entertainment system/event, gambling site, customer identification/loyalty system, drone management, drone delivery system and the like and combinations thereof.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A method of providing an augmented reality service over a computerized network utilizing a mobile web application, comprising the steps of:
a. imaging, using a user interface device operating a mobile web application, a plurality of frame-shaped augmented reality markers within a set of markers, each having an identifier that is unique within the set of markers, thereby generating set unique marker images;
b. automatically storing data in association with each of the plurality of set unique marker images, thereby generating a plurality of marker templates;
c. automatically storing the plurality of marker templates in association with each other;
d. imaging, using a user interface device operating the mobile web application, a specific frame-shaped augmented reality marker which is one of the plurality of frame-shaped augmented reality markers;
e. automatically identifying the specific frame-shaped augmented reality marker by its identifier via the mobile web application;
f. automatically displaying data associated with the specific frame-shaped augmented reality marker on an augmented reality display wherein the data displayed is registered three-dimensionally with the specific frame-shaped augmented reality marker, wherein the frame-shaped augmented reality markers include machine-readable orientation information displayed thereon.

2. The method of claim 1, wherein the identifiers are not globally unique within the system.

3. The method of claim 1, wherein the displayed data includes a hyperlink that links to additional data.

4. The method of claim 1, wherein the machine-readable orientation information includes an asymmetric bi-color frame coloring schema.

5. The method of claim 1, wherein the frame-shaped augmented reality markers include one or more access codes disposed thereon and wherein the step of automatically storing data requires an access code from at least one of the frame-shaped augmented reality markers.

6. A mobile web application operating on a mobile computing device for providing marker-based augmented reality, comprising:
a. a file input submission form that automatically uploads files into a database in associated with frame-shaped markers having machine-readable orientation information disposed thereon and frame identifiers that are unique within a set of frames but not globally unique that are scanned via a video input device; and
b. a graphical user interface that displays uploaded files in marker-based augmented reality in three dimensionally registered associated with frame-shaped markers.

7. The mobile web application of claim 6, wherein the displayed data includes a hyperlink that links to additional data.

8. The method of claim 1, wherein the machine-readable orientation information includes an asymmetric bi-color frame coloring schema.

9. The method of claim 1, wherein the frame-shaped augmented reality markers include one or more access codes disposed thereon and wherein the step of automatically storing data requires an access code from at least one of the frame-shaped augmented reality markers.

10. A system for providing augmented reality over a computerized network, comprising:
a. a plurality of distributed markers with machine-readable orientation information disposed thereon and having machine-readable identifiers disposed thereon;
b. a user interface device operating a web application having:
i. a video scanner capable of capturing video information and reading the orientation information and the identifiers of the distributed markers;
ii. a file input submission form that associates data with scanned markers thereby forming associated data and submits the associated data; and
iii. an augmented reality display that displays associated data in three-dimensional registration with captured video data and visible distributed markers; and
c. a backend system that stores associated data and provides associated data over a network to the web application when queried for the associated data by the identifier included within the associated data.

11. The system of claim 10, wherein the distributed markers are frame-shaped.

12. The system of claim 10, wherein the machine-readable identifiers are unique within a set of distributed markers but are not unique within the system.

13. The system of claim 10, wherein the machine-readable orientation information consists of asymmetric marker coloration.

14. The system of claim 10, wherein the data includers data selected from the group of data consisting of: image files, spreadsheets, and hyperlinks.

15. The system of claim 10, wherein the distributed markers include one or more access codes disposed thereon and wherein the step of automatically storing data requires an access code from at least one of the markers.
